(19) United States
(12) Patent Application Publication
(10) Pub. No.: US 2005/0221791 A1
(43) Pub. Date: Oct. 6, 2005

(54) Sensor screen saver

(75) Inventor: Anders Angelhag, Lund (SE)

Correspondence Address: JENKENS & GILCHRIST, PC, 1445 ROSS AVENUE, SUITE 3200, DALLAS, TX, 75202, US

(73) Assignee: Sony Ericsson Mobile Communications AB

(21) Appl. No.: 10/818,006

(22) Filed: Apr. 5, 2004

(51) Int. Cl. H04B 1/38

(52) U.S. Cl. 455/343.5; 455/566

(57) ABSTRACT

Mobile telephone handset or headset utilizes a sensor for determining whether a power-saving mode should be entered. The headset or handset includes at least one display screen for displaying communication information relative to the device, a sensor for providing a command signal, and control means for controlling operation of the display screen responsive to the command signal. The device has a first mode in which the display screen displays at least some information and a second mode in which the display screen utilizes less power than the first mode. The command signal causes a change between the first mode and the second mode. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### TECHNICAL FIELD

The present invention relates to communication devices, and more particularly, but not by way of limitation, to mobile telephone handsets, headsets and related communication devices utilizing sensors for facilitating reduced power consumption.

### BACKGROUND OF THE INVENTION

The popularity and worldwide acceptance of handheld mobile telephones is well recognized. This widespread use has resulted in the mobile telephone becoming a common part of both modern society and contemporary business. There are many reasons for the success of mobile telephones, and they include the inherent ease with which a user can access telephonic communication from place to place without the concern of fixed communication networks. This ease in communication access affords greater convenience for the consumer and increased efficiency for business.

It is common to carry handheld mobile telephones in pockets, on belts, in purses, and in briefcases. Such telephones are generally in the “on” condition as the user often wants the telephone to be readily available for immediate use and in a condition to receive calls. Such demands upon the function of a modern handheld mobile telephone handset have required improved efficiency in power consumption and battery life. It has thus become well-known to “power down” telephone handset screens and/or related handset functions when a pre-defined period of time has passed since last use of the screen to display information. This powering down aspect promotes extended battery life and allows the user to leave the telephone in an “on mode” for prolonged periods of time without unnecessary power loss.

From a technology background standpoint, it is well-known to use proximity sensors in telephones for activating various functions. For example, U.S. Pat. No. 5,224,151 discloses a proximity sensor for use in a handset speaker phone. This particular design utilizes an infrared range detection unit built into the handset for controlling switching between a handset mode and a speaker phone mode. Likewise, U.S. Pat. No. 5,337,353 discloses a capacity proximity sensor. In this particular design, a guard electrode and a sensor electrode separated by an insulating layer are utilized for controlling switching between a handset mode and a speaker phone mode.

It may be seen in U.S. Pat. No. 5,712,911, that a telephone system is set forth, shown, and described for activating a speaker phone in response to incoming call based upon the presence or absence of a subscriber within a predetermined proximity zone. This particular technology utilizes a proximity unit and a control unit for automatically activating the speaker phone to establish communication with the caller when the subscriber is within the predetermined proximity zone. Likewise, U.S. Pat. No. 3,109,893 discloses a proximity operated telephone in which proximity switches are used for turning the telephone on when a subscriber passes his hand near the sensor to establish communication with the caller. European Patent No. EP0541439 discloses an auditory communication device using a proximity detector to activate a microphone when a speaker is present within a predetermined proximity zone. In this particular case, the effects of ambient noise are reduced.

Finally, U.S. Pat. No. 6,532,447, assigned to Telefonaktiebolaget L M Ericsson (publ) and incorporated in its entirety herein for reference, teaches yet another use of a proximity sensor in an electronic device. In this patent, a proximity sensor is employed to provide a control signal indicative of whether an object is in proximity of the device. The control signal allows voice recognition circuitry of a mobile telephone to be enabled or disabled.

Recent developments in handheld mobile telephone technology have also led to separate earpieces, or headsets, that communicate with a linked mobile telephone handset by utilizing short-range wireless technology such as, for example, BLUETOOTH. Although the following description may utilize the term “BLUETOOTH” to describe a particular wireless scheme, it will be understood by one in the art that any short-range wireless scheme may be employed. Future BLUETOOTH headset designs should soon incorporate display screens and some of these may be color. It is well-recognized that color displays and backlights currently used in mobile telephone handsets typically and headsets consume a relatively-large amount of power when active. These design considerations are further exacerbated by commercial marketability aspects of headsets, which focus on issues such as weight, size and standby power duration.

As referenced above, certain mobile telephone handset displays go into an energy-saving mode based solely upon timing factors. While effective for handsets with relatively large batteries, telephone headsets of the BLUETOOTH variety may require even more power-saving remedies when incorporating display screens.

### SUMMARY OF THE INVENTION

The present invention relates to communication devices, and more particularly, to mobile telephone handsets, headsets and related communication devices utilizing sensors to facilitate reduced power consumption. In one embodiment, the present invention includes a communication device comprising at least one of a display screen for displaying information and a backlight for lighting a portion of the device. The device also includes a sensor for providing a command signal and control means for controlling the operation of the display screen in response to the command signal. The device has a first mode in which the display screen displays information and a second mode having lower power consumption than in the first mode, and the command signal causes a change between the first mode and the second mode. In yet another aspect of the invention, the communication device is portable, and in another embodiment comprises a mobile telephone.

In yet a further aspect, an embodiment of the invention comprises a method of controlling the operation of a display screen in a communication device comprising the steps of providing a sensor within the communication device, producing a command signal indicative of whether an object is in proximity of the device or a temperature or pressure, etc. threshold has been exceeded, and controlling the display of the device in response to the command signal. In yet another aspect of the invention, the control of the display screen controlled operation is enabled by the command signal and is terminated by the absence of a command signal.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a block diagram illustrating one embodiment of the apparatus according to the present invention;

FIG. 2 is a diagrammatical illustration of the operation of a mobile telephone headset and handset illustrating one aspect of the methods of and apparatus for the present invention;

FIG. 3 is a flow chart of one embodiment of the method according to the present invention;

FIG. 4 is a perspective view of one embodiment of a telephone headset containing the apparatus for and using the method of one embodiment of the present invention; and

FIG. 5 is a perspective view of one embodiment of a telephone handset containing the apparatus for and using the method of one embodiment of the present invention.

### DETAILED DESCRIPTION

It has been recognized by the inventor of the present application that utilization of a sensor in a communication device, such as a telephone headset, handset or other auxiliary device, can afford a user enhanced efficiency by reduced power consumption. In one embodiment of the present invention, the communication device incorporates a sensor disposed therein to detect if the device is sufficiently close to the head of the user or any other surface so as to prevent its effective viewing of the display or keypad. In this event, the display screen power, display backlight, keypad backlight, or other power consuming applications may be turned off and/or the device placed in a pre-selected energy-saving mode for reduced power consumption and prolonged battery life.

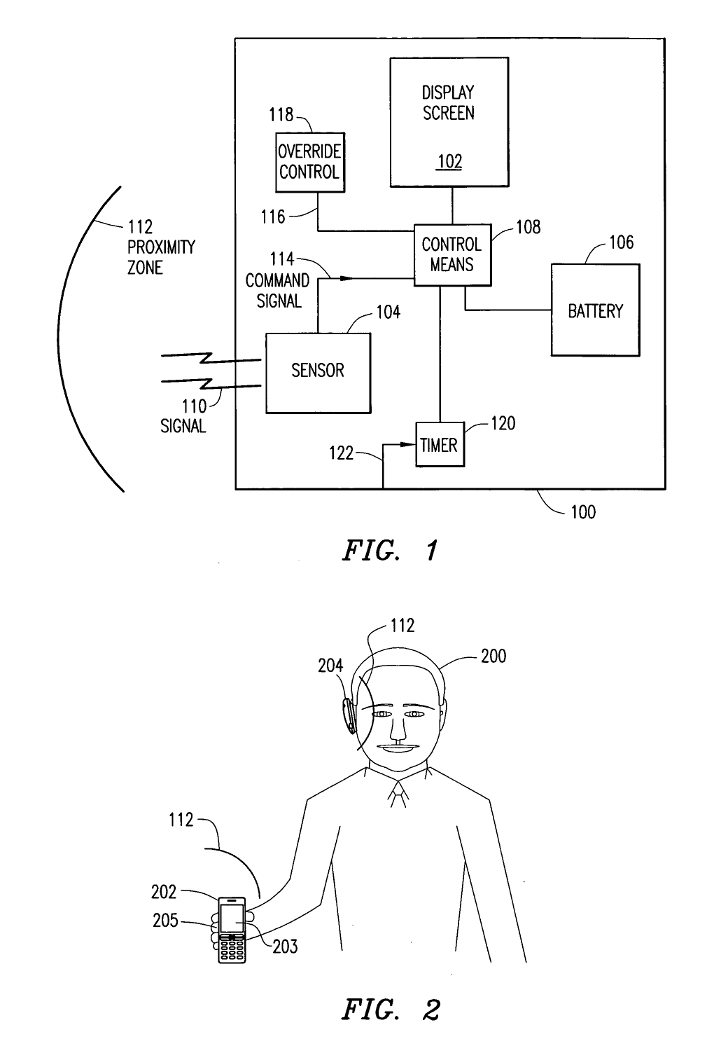

Referring now to FIG. 1, there is shown a block diagram illustrating the apparatus according to an embodiment of the present invention. As shown herein, a communication device 100, having a display screen 102, incorporates a sensor 104. Although the sensor 104 of this particular embodiment, is a proximity sensor, other sensors (i.e., pressure sensors, temperature sensors, outbound speech sensors, light sensors, etc.) may be utilized. A power source in the form of a battery 106 is provided within the communication device 100 to power the display screen 102 through a control means 108. The control means 108 is coupled to the sensor 104 and is responsive to signals generated therefrom. The sensor 104, here a proximity sensor, is adapted for processing a signal 110 alerting the sensor 104 that an object is within a proximity zone 112 and for generating an appropriate command signal 114. The command signal 114 is supplied to the control means 108 for selectively turning the power off to the display screen 102 or otherwise putting the communication device 100 into an energy-saving mode.

As noted above, the sensor 104 may be a type of sensor other than a proximity sensor. For example, if the sensor 104 is a pressure sensor, then, in this case, the signal 110 may be the pressure applied to the pressure sensor. A command signal 114 is generated based on the sensed pressure. Similarly to the pressure sensor, when employing a temperature sensor, the signal 110 may be the temperature received at the temperature sensor. The sensed temperature may indicate that the communication device 100 is near a user's head and a command signal 114 is generated based on the sensed temperature. Similar signals may be generated when, for example, a light sensor, or other type of sensor is utilized by an embodiment of the present invention.

In addition, the command signal 114 may also affect other settings of the communication device 100. For example, the communication device 100 may be operating in a vibration ring mode. In some instances, a user may desire that the communication device 100 not vibrate for an incoming call. An aspect of the present invention prevents the communication device 100 from ringing or vibrating when the command signal 114 sent to the control means 108 indicates that the display screen 102 should be put into a power-saving mode. In another embodiment, settings may cause the display screen 102 to be put into a power-saving mode. For example, a meeting setting may cause the communication device 100 not to ring or vibrate when there is an incoming call. The meeting setting may also cause the display screen 102 to be put into a power-saving mode. Furthermore, the sensor 104 may be utilized in conjunction with other settings, a timer, application, etc. for effecting a power-saving mode. For example, although the sensor 104 does not detect a condition for entering a power-saving mode, a timer may be utilized to determine when an amount of time lapses without activity. In this instance, the communication device 100 may enter a power-saving mode due to the timer exceeding a predetermined time interval.

The sensor 104, if a proximity sensor, may be a capacitive, inductive, temperature, IR, or other variety of sensor capable of detecting whether an object is present in the proximity zone 112. A primary object of detection for the proximity zone 112 may be the head of the user or any other object that would prevent viewing of the display screen 102. In this regard, an override signal 116 can be emitted by an override control 118, allowing the user or the communication device to reactivate the display screen 102 even though an object is sensed within the proximity zone 112, the pressure sensed exceeds a predetermined threshold, a temperature sensed exceeds a predetermined threshold, etc. The override control 118 may be used, for example, when the user has inadvertently covered the sensor 104 or desires for the display screen to remain activated even though the sensor 104 detects an object within the proximity zone 112 or the predetermined threshold is exceeded in the temperature or pressure sensor. In addition, the override control 118 may be activated when the communication device receives an incoming call. In this way, the user may view the phone number of the calling party.

Still referring to FIG. 1, in one embodiment of the present invention, the sensor 104 may function in its output as a simple switch having the signal 110 as the controlling switch signal, so when the signal 110 is, e.g. high (1), the command signal 114 is output from the sensor 104. When the signal 110 is, e.g. low (0), nothing is output from the sensor 104. In a similar manner, the command signal 114 may be output from the sensor 104 when a sensed pressure or temperature, etc. exceeds a predetermined threshold. When the sensed pressure or temperature, etc. does not exceed a predetermined threshold, then no signal may be output from the sensor 104. In another option, a command signal 114 may be sent at predetermined intervals.

Other control systems may be incorporated for the control of the display screen, including activation or deactivation of power thereto, as is conventional in the prior art for mobile telephone technology. For example, the display screen 102 may also be powered down through the control means 108 after a defined period of time, as recognized by a timer 120 that detects use of the communication device 100 through a signal 122, has elapsed. In this manner, the display screen 102 in position to be viewed by a user may be powered down in accordance with existing screen saver/power consumption standards whether or not the sensor 104 detects that the display screen 102 should be powered down. This may occur, for example, when the communication device 100 is simply left on for a prolonged period of time.

In addition to entering a power-saving mode, the sensor 104 and command signal 114 may be utilized to restore power to a portion of the device previously in a power-saving mode. For example, when the communication device 100 is in close proximity to an object, such as a user's head, then the display, keypad backlight, other power-consuming applications, etc. may be put into a power-saving mode. When the sensor 104 senses that the communication device 100 is no longer in close proximity to an object, the display, keypad backlight, etc. may be authorized to return to a power-consuming mode.

Referring now to FIG. 2, there is shown a diagrammatic illustration of a user 200 holding a telephone handset 202 connected via BLUETOOTH to a telephone headset 204. It may be seen that while the headset 204 is too close to the user 200 for the user to view any display screen provided therein, the telephone handset 202, which may include a display screen 203, is a sufficient distance from the user 200 to allow viewing of said display screen 203. In one embodiment of the present invention, the handset 202 and the headset 204 each incorporate a sensor in accordance with principles of the present invention in order to afford reduced power consumption in the various communication devices. Alternatively, the handset 202 may have a sensor and the headset 204 may not include a sensor or vice versa. In this embodiment, the display screen 203 in the headset 204 (not shown in this view) would be “powered down” by the sensor 104, while the display screen 203 on the handset 202 would remain “on” due to the distance of the user 200 relative to each. It may be seen that an object, e.g., the user's head, may be within the proximity zone 112 of the headset 204, while the object may be outside the proximity zone 112 of the handset 202. In this regard, it may be seen that the orientation of, as well as type of, the sensor 104 used in the particular communication device may vary due to the manner in which each of the handset 202 and the handset 204 is handled. For example, the handset 202 may be held by the user 200 in such a way that a sensor thereof should not shut down a display screen thereof merely by the presence of a user's hand 205. The same may be said of the headset 204, which will often be held by the user, but due to the design of the headset 204, the user may have more flexibility in holding the headset 204 in a manner not prone to activate a sensor thereof. It should be noted, however, that an override control such as the above-described override control 118 may be provided in such communication devices for just such situations where the user 200 does not orient and/or handle and/or otherwise carry the particular communication device in a manner that would typically cause a command signal such as the command signal 114 to a control means such as be sent to the control means 108.

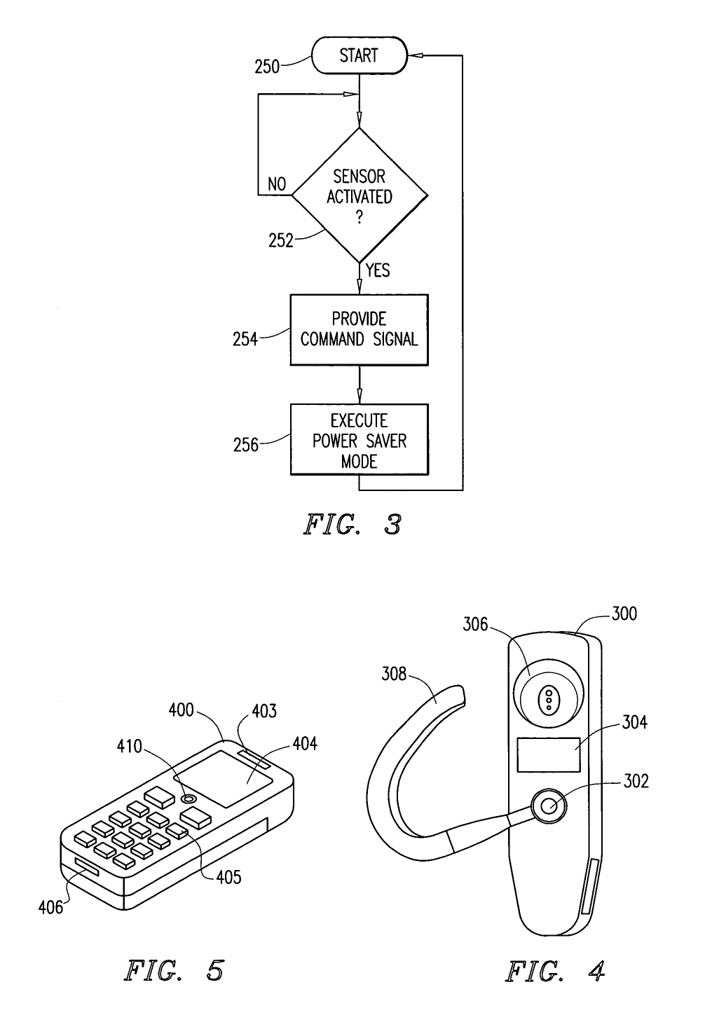

Referring now to FIG. 3, there is shown a flow chart of a method according to principles of the present invention. In step 250, the method is initialized. In step 252, a test of whether the sensor 104 is activated occurs. Activation at step 252 may occur, for example, when a proximity sensor detects a presence within a predetermined proximity zone or a predetermined pressure or temperature threshold has been exceeded. If an object is detected, the command signal 114 is provided to the control means 108 in step 254. If not, the method loops back and executes the test again after a pre-selected time interval. If the sensor 104 is activated at step 252 and the command signal 114 is generated at step 254, then a power-saving mode is executed in step 256. From step 256 the method loops back to the beginning of the flow chart (i.e., step 250), and the test in step 252 is executed again. The method flow described above is repeated continually until the sensor 104 is no longer activated at step 252 or the communication device 100 is shut down.

Referring now to FIG. 4, there is shown a perspective view of one embodiment of the invention embodied in a telephone headset. In this particular embodiment, a telephone headset 300 contains a sensor 302 and a display screen 304. The headset 300 further includes a speaker 306 for placement in a user's ear. An arcuate hangar body section 308 is provided for securement of the speaker 306 to the user's ear in a manner facilitating both comfort and stability of the speaker 306 for the user. Although this embodiment of the present invention includes an arcuate hangar body section 308, various other means of securing the headset 300 may be utilized in accordance with embodiments of the present invention. Other aspects of such a headset are conventional in the prior art and may include BLUETOOTH communication means for coupling with a telephone handset or the like.

Still referring to FIG. 4, the sensor 302 detects a change in pressure, temperature, light, speech, proximity zone, etc., when the headset 300 is placed within a predetermined proximity of the user's head or an other object. The sensor 302 thus enables the headset 300 to execute a power-saving mode for the display screen 304, keypad backlight, display backlight, or other power consuming features of the headset 300 for ensuring efficient power consumption.

Referring now to FIG. 5, there is shown a mobile telephone handset 400 including one embodiment of the method of and apparatus of the present invention. The mobile telephone handset 400 has a display screen 404, a keypad 405, a microphone 406, and a speaker 403. The microphone 406 and the speaker 403 are connected to an electrical circuit that provides communication of, for example, speech signals. The display screen 404 may be further connected either directly or indirectly to a sensor 410, which detects a change in temperature, pressure, light, proximity, etc. when the display screen 404 is too close to an object to be easily viewable by the user. The sensor 410 thus enables the display screen 404 to be powered down when not in a position for efficient use, which saves power for the user.

Although the above description illustrates utilizing one sensor to aid in determining the mode of operation of the display or backlight, multiple sensors may be employed to determine the mode of operation of the display or backlight. For example, a pressure sensor and a light sensor may be utilized to determine whether a portion of the device should enter a power-saving mode. Furthermore, embodiments of the present invention may cooperate with other applications, timers, settings, etc. for determining whether a portion of the device should enter a power-saving mode.

It is thus believed that the operation and construction of various embodiments of the present invention will be apparent from the foregoing Detailed Description. While various devices have been described, it will be obvious to a person of ordinary skill in the art that various changes and modifications may be made therein without departing from the spirit and scope of the invention, as defined in the following claims. Therefore, the spirit and the scope of the appended claims should not be limited to the description of the embodiments contained herein.

1. A communication device comprising:
at least one of a display screen for displaying information and a backlight for lighting a portion of the device;
a sensor for providing a command signal;
control means for controlling the operation of the device in response to the command signal;
wherein the device has a first mode in which the device utilizes power and a second mode in which the device utilizes less power than the first mode; and
wherein the command signal causes a change between the first mode and the second mode.

2. The communication device of claim 1, wherein the device is portable.

3. The communication device of claim 2, wherein the device comprises a mobile telephone.

4. The communication device of claim 2, wherein the device comprises a mobile telephone headset.

5. The communication device of claim 1, wherein the sensor is adapted for detecting a head of a user adjacent the display screen for reduced power consumption.

6. The communication device of claim 1, wherein the sensor comprises a proximity sensor for sensing an object within a predetermined proximity zone.

7. The communication device of claim 1, wherein the sensor comprises a pressure sensor for sensing when a pressure has passed a predetermined threshold.

8. The communication device of claim 1, wherein the sensor comprises a temperature sensor for sensing when a temperature has passed a predetermined threshold.

9. The communication device of claim 1, wherein the sensor comprises a light sensor for sensing when an amount of light has passed a predetermined threshold.

10. The communication device of claim 1, wherein the sensor comprises two sensors working in conjunction with each other to determine whether a change between the first mode and the second mode should be made.

11. The communication device of claim 1, wherein the sensor works in conjunction with a timer to determine whether a change between the first mode and the second mode should be made.

12. The communication device of claim 1, wherein the sensor works in conjunction with an application to determine whether a change between the first mode and the second mode should be made.

13. A method of controlling the operation of a communication device, the method comprising the steps of:
providing at least one sensor within the communication device;
transmitting a command signal for controlling operation of the device; and
controlling an amount of power provided to a portion of the device in response to the command signal.

14. The method of claim 13, wherein the controlling step is responsive to receipt of the command step.

15. The method of claim 14, further comprising terminating the controlling step responsive to non-receipt of the command signal.

16. The method of claim 13, wherein the step of providing a command signal is repeated at predetermined intervals.

17. The method of claim 13, wherein the sensor is a proximity sensor for sensing an object within a predetermined proximity zone.

18. The method of claim 13, wherein the sensor is a pressure sensor for sensing when a pressure has passed a predetermined threshold.

19. The method of claim 13, wherein the sensor is a temperature sensor for sensing when a temperature has passed a predetermined threshold.

20. The method of claim 13, wherein the sensor is a light sensor for sensing when an amount of light has passed a predetermined threshold.

21. The method of claim 13, wherein the at least one sensor comprises two sensors working in conjunction with each other to determine whether a change between the first mode and the second mode should be made.

22. The method of claim 13, comprising providing a timer, working in conjunction with the sensor, to determine whether a change between the first mode and the second mode should be made.

23. The method of claim 13, comprising providing an application, working in conjunction with the sensor, to determine whether a change between the first mode and the second mode should be made.
